(19) United States
(12) Patent Application Publication
(10) Pub. No.: US 2011/0139113 A1
(43) Pub. Date: Jun. 16, 2011

(54) Compound Sealing Mechanism, Cylinder Liner, And Engine Assembly Method

(75) Inventors: Dion R. Miller, Princeville, IL (US); Franklin Struwe, East Peoria, IL (US); Jonathan R. Chittenden, Peoria, IL (US)

(73) Assignee: CATERPILLAR INC., Peoria, IL (US)

(21) Appl. No.: 12/951,401

(22) Filed: Nov. 22, 2010

Related U.S. Application Data
(60) Provisional application No. 61/285,614, filed on Dec. 11, 2009.

(51) Int. Cl. F02F 11/00; F02F 1/00; B23P 19/00

(52) U.S. Cl. 123/193.3; 123/193.2; 29/700

(57) ABSTRACT

A cylinder liner and compound seal assembly for an internal combustion engine includes a cylinder liner having a liner body with an outer surface and an inner surface defining a longitudinal bore. The cylinder liner further includes a first axial end, and a second axial end which includes a sealing surface and a protective end projection extending in an axial direction from the sealing surface. A compound sealing mechanism for establishing seals between an engine head and an engine housing includes a one-piece gasket body having an outer radial region and an inner radial region which includes a combustion seal having an engine head sealing surface and a cylinder liner sealing surface, and a recess formed in the lower surface and located radially outward of the cylinder liner sealing surface and configured to receive therein a protective end projection of the cylinder liner. The recess may include a continuous annular recess circumferential of a center axis of a cylinder opening formed in the one-piece gasket body, and positioned adjacent the cylinder liner sealing surface. The protective end projection may include a continuous annular projection arranged coaxially with the longitudinal bore and positioned adjacent an inner surface of the cylinder liner.

### CROSS-REFERENCE TO RELATED PATENT APPLICATIONS

This application claims priority to provisional U.S. patent application Ser. No. 61/285,614, filed Dec. 11, 2009, entitled “Compound Sealing Mechanism, Cylinder Liner, And Engine Assembly Method.”

### TECHNICAL FIELD

The present disclosure relates generally to combustion sealing strategies for internal combustion engines, and relates more particularly to establishing a combustion seal by way of a one-piece gasket body shaped to accommodate a protective end projection of a cylinder liner.

### BACKGROUND

A wide variety of sealing strategies are used in connection with internal combustion engine cylinders. The use of a head gasket having various fluid transfer apertures formed therein for sealing fluid transfer passages between an engine housing and engine head has long been known in the art. Many conventional engines also utilize a separate combustion seal positioned between the engine head and the engine housing, which seals between the engine head and the engine housing or a cylinder liner to contain combustion gases. The head gasket may be formed as a part separate from the combustion seal, and surrounds the combustion seal when positioned for service in an engine. Both the head gasket and the combustion seal may be subjected to relatively high sealing loads to enable the components to withstand relatively high combustion pressures and temperatures without deformation or failure. In the high pressure environment of compression ignition engines, robust design and sealing of such components may be particularly desirable. While certain strategies for the design and implementation of head gaskets and combustion seals have been successful for many years, they tend to have certain drawbacks.

U.S. Pat. No. 4,474,147 to Hoopes discloses one example seal mechanism for an engine. The seal includes a ring purportedly capable of ensuring an effective seal with an engine block or cylinder sleeve. While Hoopes may be effective in certain environments, the concepts are not readily applicable to engines having certain configurations. Other attempts at effective sealing have involved the use of relatively heavy sealing loads applied to combustion seals in contact with relatively thick-walled cylinder liners.

### SUMMARY

In one aspect, a compound sealing mechanism for sealing between an engine head and an engine housing of an internal combustion engine includes a one-piece gasket body including an outer perimeter and an inner perimeter. The inner perimeter defines a cylinder opening having a center axis. The one-piece gasket body further includes an upper surface extending in a radial direction between the inner perimeter and the outer perimeter, a lower surface positioned opposite the upper surface, and an outer radial region which includes a plurality of apertures communicating between the upper surface and the lower surface. The one-piece gasket body further includes an inner radial region which includes a combustion seal having an engine head sealing surface and a cylinder liner sealing surface. The cylinder liner sealing surface includes a portion of the lower surface and is positioned adjacent the inner perimeter. The one-piece gasket body further includes a recess in the lower surface located radially outward of the cylinder liner sealing surface and being configured to received therein a protective end projection of a cylinder liner.

In another aspect, a cylinder liner for an internal combustion engine includes a liner body having a liner wall with an outer surface and an inner surface defining a first longitudinal bore with a first bore diameter and a second longitudinal bore with a second bore diameter which is greater than the first bore diameter. The first longitudinal bore and the second longitudinal bore define a common longitudinal axis. The liner body further includes a first axial end, a second axial end and a plurality of axial segments, including a first axial segment which includes the first axial end and the first longitudinal bore, and a second axial segment which includes the second axial end and the second longitudinal bore. The first axial segment includes a first segment diameter and the second axial segment includes a second segment diameter which is greater than the first segment diameter. The second axial end includes a sealing surface extending in a radial direction between the inner surface and the outer surface, and a protective end projection adjoining the sealing surface and projecting in an axial direction from the sealing surface. The sealing surface is located adjacent to the inner surface, and the protective end projection is positioned relatively closer to the outer surface than to the inner surface. The first axial segment includes a wall thickness of the liner wall between the inner surface and the outer surface, the wall thickness being equal to about 12% or less of the first bore diameter.

In still another aspect, a cylinder liner and compound seal assembly for an internal combustion engine includes a cylinder liner having a liner body with an outer surface and an inner surface defining a longitudinal bore which includes a longitudinal axis. The cylinder liner further includes a first axial end, a second axial end which includes a sealing surface extending in a radial direction between the inner surface and the outer surface, and a protective end projection extending in an axial direction from the sealing surface. The assembly further includes a compound sealing mechanism including a one-piece gasket body having an outer perimeter and an inner perimeter defining a cylinder opening which includes a center axis. The one-piece gasket body further includes an upper surface extending in a radial direction between the inner perimeter and the outer perimeter, a lower surface positioned opposite the upper surface, and an outer radial region which includes a plurality of apertures communicating between the upper surface and the lower surface. The one-piece gasket body further includes an inner radial region which includes a combustion seal having an engine head sealing surface and a cylinder liner sealing surface. The cylinder liner sealing surface includes a portion of the lower surface and is positioned adjacent the inner perimeter. The one-piece gasket body further includes a recess in the lower surface located radially outward of the cylinder liner sealing surface and being configured to receive therein the protective end projection of the cylinder liner.

In still another aspect, a method of assembling an internal combustion engine includes the steps of contacting a cylinder liner sealing surface of a combustion seal with a cylinder liner positioned within an engine housing of the internal combustion engine, and contacting an engine head sealing surface of the combustion seal with an engine head of the internal combustion engine. The method further includes the steps of receiving a protective end projection of the cylinder liner within a recess formed in a lower surface of a one-piece gasket body which includes the combustion seal, and applying a sealing load to the one-piece gasket body at least in part via a step of clamping the one-piece gasket body between the engine head and the engine housing.

### BRIEF DESCRIPTION OF THE DRAWINGS

FIG. 1 is a sectioned side diagrammatic view of an internal combustion engine, according to one embodiment;

FIG. 2 is an elevational view of a compound sealing mechanism, according to one embodiment;

FIG. 3 is an isometric view of a portion of an internal combustion engine, according to one embodiment;

FIG. 4 is a partially sectioned side diagrammatic view of a cylinder liner, according to one embodiment;

FIG. 5 is a sectioned side diagrammatic view of a compound sealing mechanism and cylinder liner assembly, according to one embodiment; and

FIG. 6 is a partially sectioned side diagrammatic view of an internal combustion engine at an assembly stage, according to one embodiment.

### DETAILED DESCRIPTION

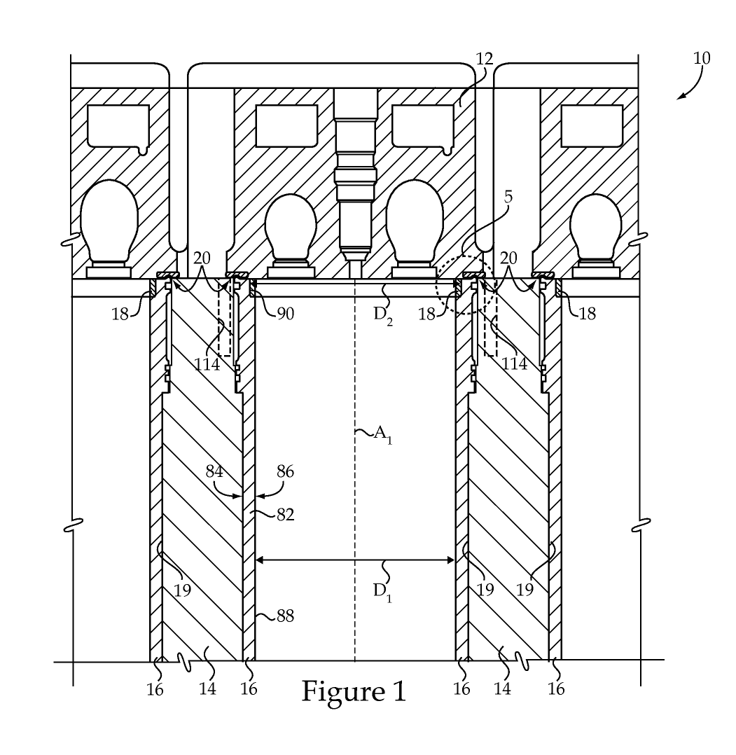

Referring to FIG. 1, there is shown an internal combustion engine 10 according to one embodiment. Internal combustion engine 10 may include a direct injection compression ignition diesel engine. Alternatives are contemplated, however, such as spark ignited engines, including natural gas engines, port injected engines, etc. Engine 10 may include an engine head 12 and an engine housing 14. Engine head 12 may include a composite engine head wherein a plurality of different engine head units are coupled with engine housing 14, but could include a unitary head design in certain embodiments. Engine housing 14 may define a plurality of cylinders 19, each having a cylinder liner 16 positioned therein. Certain details of engine 10 such as pistons, crankshaft, camshaft, etc., are omitted from the FIG. 1 depiction, however, such components are well known in the art. A plurality of compound sealing mechanisms 20 for sealing between engine head 12 and engine housing 14 are shown in FIG. 1 and are associated one with each of cylinders 19, certain details of which are further explained herein. In the embodiments shown, each cylinder liner 16 may include a liner body 80, an outer surface 84, an inner surface 86 and a liner wall 82 whereupon surfaces 84 and 86 are located. Inner surface 86 may define a first longitudinal bore 88 and a second longitudinal bore 90. Longitudinal bores 88 and 90 may define a common longitudinal axis A₁. First longitudinal bore 88 may include a first bore diameter D₁, and second longitudinal bore 90 may include a second bore diameter D₂ which is greater than first bore diameter D₁. A cuff ring 18 or the like may be positioned between second longitudinal bore 90 and configured to scrape carbon deposits, etc., from a piston associated with the corresponding cylinder 19, in a well known manner.

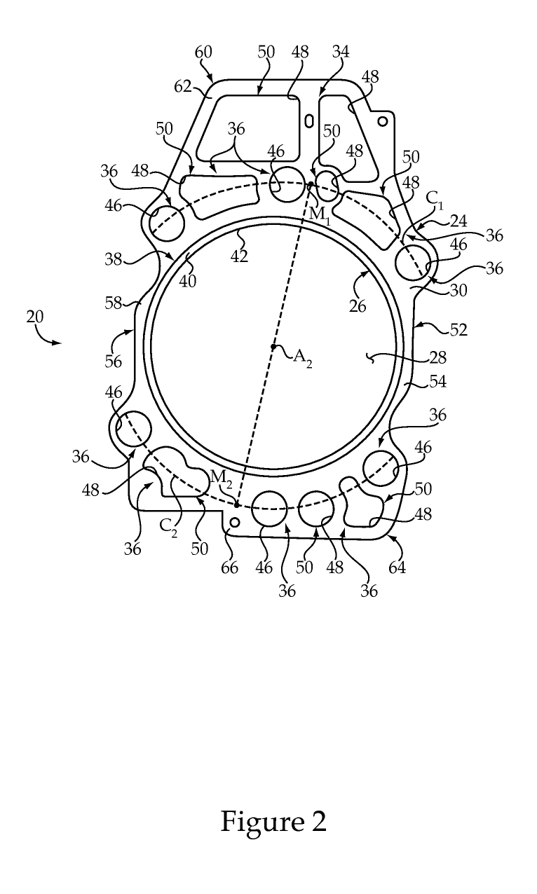

Turning to FIG. 2, there are shown certain details of compound sealing mechanism 20 in more detail. Compound sealing mechanism 20 may include a one-piece gasket body 22 having an outer perimeter 24 and an inner perimeter 26 which defines a cylinder opening 28 having a center axis A₂. Gasket body 22 may further include an upper surface 30 extending in a radial direction, i.e. a direction normal to an orientation of axis A₂, between inner perimeter 26 and outer perimeter 24. Gasket body 22 may further include a lower surface (not visible in FIG. 2) positioned opposite upper surface 30, and an outer radial region 34 which includes a plurality of apertures 36 communicating between upper surface 30 and the lower surface. Gasket body 22 may further include an inner radial region 38 which includes a combustion seal 40 having a engine head sealing surface 42 and a cylinder liner sealing surface (not visible in FIG. 2).

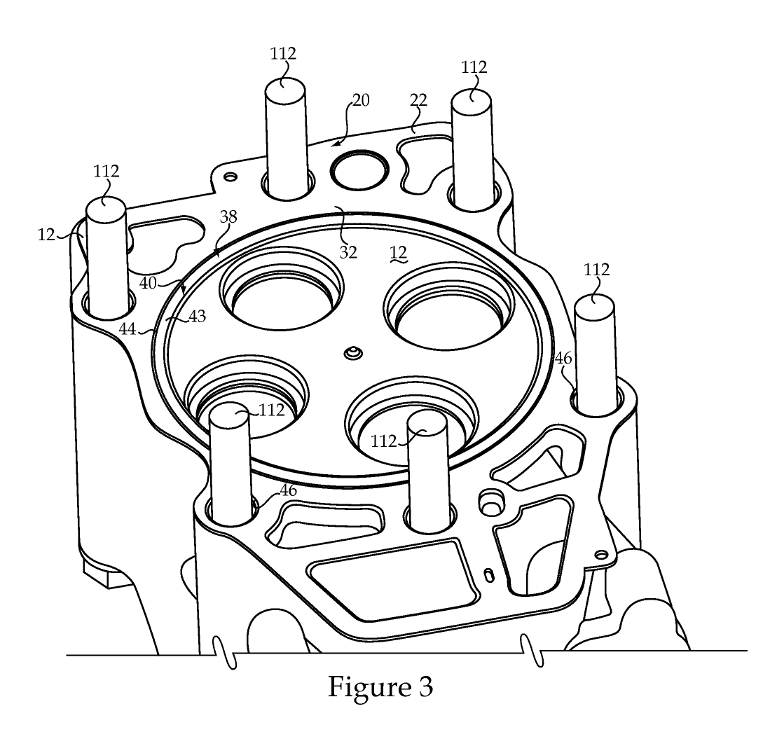

Referring also to FIG. 3, there is shown gasket body 22 in a view flipped over relative to the view shown in FIG. 2, and also illustrating portions of engine head 12 and a set of bolts 112 for clamping gasket body 22 between engine head 12 and engine housing 14. Engine housing 14 is not shown in FIG. 3, and lower surface 32 and cylinder liner sealing surface 43 are visible. Also illustrated in FIG. 3 is a recess 44 formed in lower surface 32, such as by machining, and located radially outward of cylinder liner sealing surface 43. Recess 44 is configured to receive therein a protective end projection of a cylinder liner such as one of cylinder liners 16, as further described herein. Cylinder opening 28 may include a circular shape, and in one embodiment recess 44 may include a continuous annular recess circumferential of center axis A₂ and adjoining cylinder liner sealing surface 43. In other embodiments, recess 44 might be discontinuous, and could for instance comprise a plurality of recesses formed in lower surface 32 and configured to receive a plurality of protective end projections of a cylinder liner. As used herein, the term “adjoining” should be understood to mean that a given component or feature is positioned directly next to another component or feature of interest. In contrast, the term “adjacent” means that a component or feature of a given type is the closest component or feature of the given type to another component or feature of interest.

As mentioned above, a plurality of apertures 36 may be positioned in outer radial region 34. In one embodiment, apertures 36 may include a set of bolting apertures 46 arranged in a first radial pattern about axis A₂, and a set of fluid transfer apertures 48 arranged in a second radial pattern about axis A₂ which is different from the first radial pattern. A plurality of fluid transfer seals 50 may also be located in outer radial region 34 and associated one with each of fluid transfer apertures 48. Accordingly, when engine head 12 is coupled with engine housing 14, gasket body 22 may fluidly seal passages extending between engine head 12 and engine housing 14 via fluid transfer seals 50 under a compressive clamping load between engine head 12 and engine housing 14. A similar sealing strategy is used with regard to combustion seal 40, as further described herein.

It will be readily apparent to those skilled in the art that the design of gasket body 22 renders it suitable for use with a single cylinder 19 in engine 10. In other words, rather than a sealing mechanism such as certain conventional head gaskets which are configured to provide seals associated with multiple engine cylinders, gasket body 22 is one of a plurality of separate compound sealing mechanisms which may each be used with one cylinder in an engine having a plurality of cylinders. To this end, gasket body 22 may have a unique configuration for providing each of a plurality of fluid seals associated with a given engine cylinder. Outer perimeter 24 may include a non-uniform outer perimeter having a first perimeter segment 52 defining a first minor lobe 54 of outer radial region 34, and a second perimeter segment 56 defining a second minor lobe 58 of outer radial region 34. Outer perimeter 24 may further include a third perimeter segment 60 located between first perimeter segment 52 and second perimeter segment 56 and defining a first major lobe 62 of outer radial region 34. Outer perimeter 24 may further include a fourth perimeter segment 64 also located between first perimeter segment 52 and second perimeter segment 56 and opposite third perimeter segment 60, which defines a second major lobe 66 of outer radial region 34. Major lobes 62 and 66 may be larger than minor lobes 54 and 58.

A first number of bolting apertures 46 may be located in first major lobe 62, whereas a second number of bolting apertures 46 equal to the first number may be located in second major lobe 66. Fluid transfer apertures 48 may be located in first major lobe 62 and also in second major lobe 66. A number of fluid transfer apertures 48 located in the respective lobes 62 and 66 may differ. In the embodiments shown, five fluid transfer apertures 48 are located in first major lobe 62 whereas three fluid transfer apertures 48 are located in second major lobe 66. Three of bolting apertures 46 may be located in first major lobe 62 whereas three of bolting apertures 46 may also be located in second major lobe 66. The bolting apertures 46 located in first major lobe 62 may define a first arc C₁ of a circle arranged coaxially with cylinder opening 28, whereas the bolting apertures 46 located in second major lobe 66 may define a second arc C₂ of the same circle. First arc C₁ may include a first midpoint M₁, second arc C₂ may include a second midpoint M₂, and a line segment defined by first midpoint M₁ and second midpoint M₂ may intersect center axis A₂ of cylinder opening 28. Other configurations are contemplated, wherein bolting apertures 46 are arranged relatively less symmetrically about axis A₂, however, the relative symmetries depicted in the drawings and described herein are contemplated to provide one practical implementation strategy.

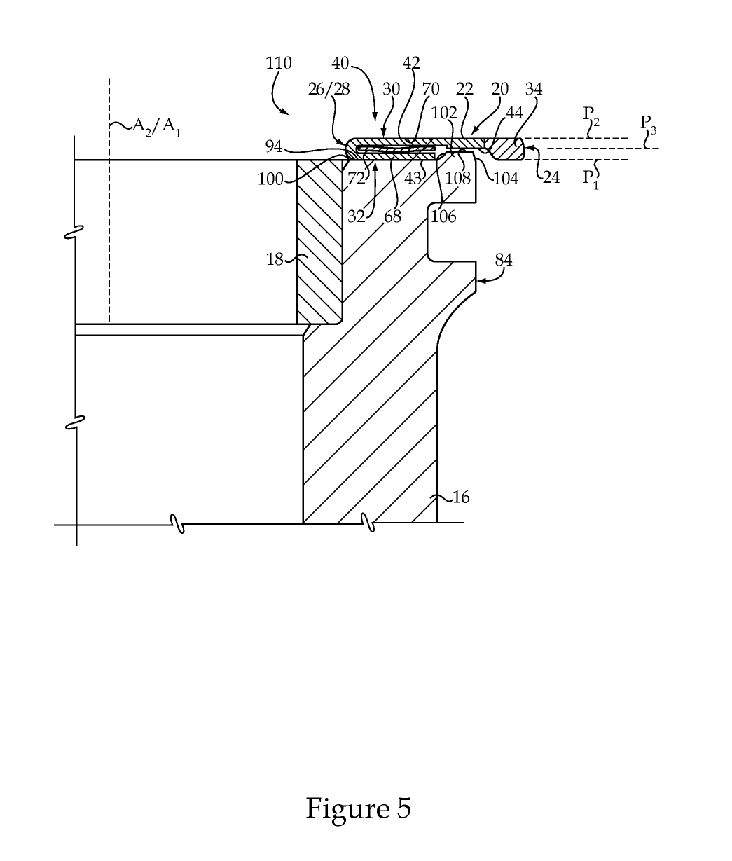

Referring also to FIG. 5, there is shown a portion of a cylinder liner and compound seal assembly 110 for an internal combustion engine such as internal combustion engine 10, showing certain components in more detail and corresponding approximately to the portion of FIG. 1 identified with dashed circle 5. Like numerals are used to denote features alike to those used in connection with the other drawings described herein. As discussed above, combustion seal 40 may include engine head sealing surface 42 and cylinder liner sealing surface 43. Cylinder liner sealing surface 43 may include a portion of lower surface 32, and recess 44 may be formed in lower surface 42 and located radially outward of cylinder liner sealing surface 43. As also discussed above, recess 44 is configured to receive therein a protective end projection of a cylinder liner. In FIG. 5, a protective end projection 102 of a cylinder liner 16 is shown received in recess 44. Cylinder liner sealing surface 43 may include a planar surface defining a first sealing plane P₁ and engine head sealing surface 42 may also include a planar sealing surface defining a second sealing plane P₂ parallel to first sealing plane P₁. Cylinder liner sealing surface 43 and engine head sealing surface 42 may each be positioned adjacent inner perimeter 26 at overlapping radial positions relative to center axis A₂. In one embodiment, cylinder liner sealing surface 43 and engine head sealing surface 42 may include identical radial positions relative to center axis A₂. In other words, cylinder liner sealing surface 43, may extend a radial distance normal to axis A₂ which is equal to a radial distance which engine head sealing surface 42 extends normal to axis A₂. In other embodiments, non-overlapping or radially offset sealing surfaces might be used.

Combustion seal 40 may include a multi-layer combustion seal having a plurality of sheets of material between cylinder liner sealing surface 43 and engine head sealing surface 42. In particular, combustion seal 40 may include a first metallic sheet 68 which includes cylinder liner sealing surface 43, a second metallic sheet 70 which includes engine head sealing surface 42, and a third metallic sheet 72 sandwiched between first metallic sheet 68 and second metallic sheet 70. In one embodiment, first and second metallic sheets 68 and 70 may include different portions of one metallic sheet which is folded around third metallic sheet 72. Third metallic sheet 72 may include a metallic spring sheet having a planar loaded state and a non-planar unloaded state. In FIG. 5, metallic spring sheet 72 is shown approximately as it might appear in an unloaded state where no sealing load is applied to combustion seal 40. When a sealing load of sufficient magnitude is applied, metallic spring sheet 72 may be expected to deform from the configuration shown in FIG. 5 to a more planar configuration. Outer radial region 44 may include material different from material of which combustion seal 40 is formed, or outer radial region 44 might include a continuation of material used to form one or both of sheets 68 and 70. In still other embodiments, combustion seal 40 might include a uniform piece of material having both of surfaces 42 and 43 located thereon.

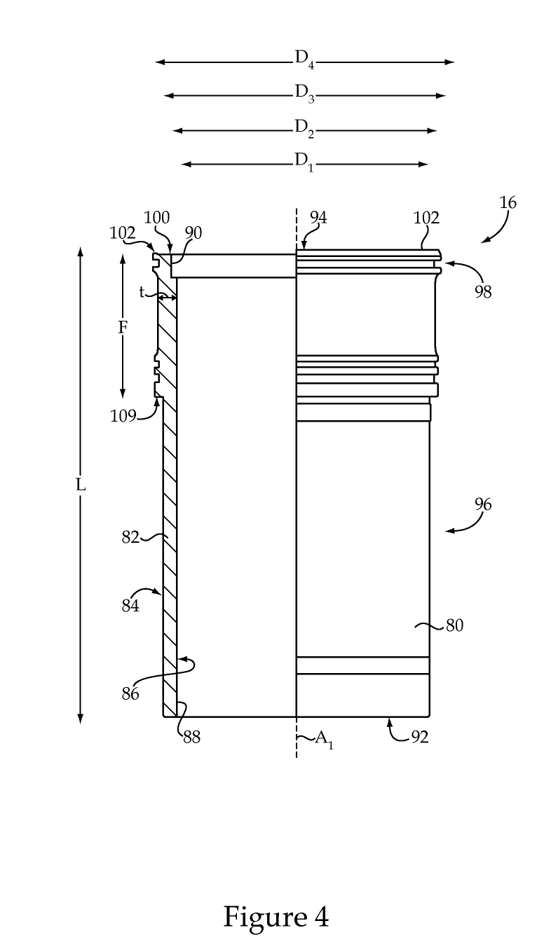

Referring now to FIG. 4, there is shown a view, partially sectioned and partially in elevation, of a cylinder liner 16 according to one embodiment. Cylinder liner 16 may be identical to other cylinder liners depicted in other drawings and described herein. As discussed above, cylinder liner 16 may include a liner body 80 having liner wall 82 which includes outer surface 84 and inner surface 86. Liner body 80 may further include a first axial end 92, a second axial end 94 and a plurality of axial segments, including a first axial segment 96 which includes first axial end 92 and first longitudinal bore 88. The plurality of axial segments may further include a second axial segment 98 which includes second axial end 94 and second longitudinal bore 90. Second longitudinal bore 90 may comprise a cuff ring bore configured to receive a cuff ring 18 as shown in FIG. 1 and FIG. 5. First axial segment 96 may include a first segment diameter D₃ whereas second axial segment 98 may include a second segment diameter D₄ which is greater than first segment diameter D₃. Diameter D₃ and Diameter D₄ include dimensions extending in a direction normal to axis A₂ between widest points of the respective axial segments 96 and 98, and intersecting axis A₂.

Second axial end 94 may further include a sealing surface 100 extending in a radial direction between inner surface 86 and outer surface 84, and configured to fluidly seal with cylinder liner sealing surface 43 of combustion seal 40. Protective end projection 102 may also be located on second axial end 94 and adjoins sealing surface 100. Protective end projection 102 is provided at least in part to protect sealing surface 100 from damage during handling and/or assembly of an associated internal combustion engine such as engine 10. Protective end projection 102 may project in an axial direction from sealing surface 100, and in certain embodiments may include a uniform axial height dimension, parallel axis A₁, which is less than about 1.0 millimeters. An axial height of end projection 102 may also be less than about 0.75 millimeters. As used herein, “about” 1.0 millimeters may be understood to mean between 0.95 millimeters and 1.04 millimeters, whereas “about”0.75 millimeters may be understood to mean between 0.70 and 0.79 millimeters. Protective end projection 102 may be located adjacent to outer surface 84 and positioned relatively closer to outer surface 84 than to inner surface 86. First axial segment 96 may include a wall thickness t of liner wall 82 in a region between second bore 90 and a liner seat 109 which is equal to about 12% or less of first bore diameter D₁. Wall thickness t may be understood as a radial thickness between inner surface 86 and outer surface 84, and may also be equal to about 8% or less of first bore diameter D₁ in certain embodiments. As used herein, “about” 8% may be understood to mean between 7.5% and 8.4%, and “about” 12% may be understood to mean between 11.5% and 12.4%. Similar conventions may be understood to apply to other numeric quantities or percentages used herein.

A distance from sealing surface 100 to liner seat 109 defines a liner flange height F, and a distance from first axial end 92 to second axial end 94 defines a liner length L. In one embodiment, liner flange height F may be equal to about 60% or less of first bore diameter D₁, and liner flange height F may further be equal to about 30% or more of liner length L. In one further embodiment, first bore diameter D₁ may be equal to about 150 millimeters or less, wall thickness t may be equal to about 12 millimeters or less, liner flange height F may be equal to about 85 millimeters or less and liner length L may be equal to about 300 millimeters or less.

Returning to FIG. 5, there are shown additional features of liner 16. As discussed above, recess 44 may include a continuous annular recess which is co-axial with cylinder opening 28. To enable receipt of end projection 102 in recess 44, end projection 102 may include a continuous annular projection having appropriate dimensions such that end projection 102 can fit readily within recess 44. When a sealing load is applied to combustion seal 40, it may be desirable to avoid loading end projection 102. To this end, an axial height of end projection 102 may be less than a corresponding axial depth of recess 44 such that end projection 102 does not actually contact gasket body 22 when gasket body 22 is assembled with other components of engine 10 and clamped between engine head 12 and cylinder liner 16. Similarly, a radial width of end projection 102 in a direction normal to axis A₁ may be less than a corresponding radial width of recess 44, in at least certain embodiments. The height/length and width of end projection 102 may be relatively small compared to corresponding height/length and width dimensions of cylinder liner 16. End projection 102 may further adjoin outer surface 84 of cylinder liner 16 and may be co-axial with first and second longitudinal bores 88 and 90. Also shown in FIG. 5 is a sealing plane defined by sealing surface 100, co-planar with plane P₁ in FIG. 5 and therefore identified with the same reference numeral P₁. End projection 102 may further include a first machined edge surface 104 transitioning to and adjoining outer surface 84 of cylinder liner 16. End projection 102 may still further include a second machined edge surface 106 transitioning to and adjoining sealing surface 100, and a machined planar axial end surface 108 extending from first edge surface 104 to second edge surface 106 and defining another plane P₃ parallel to plane P₁. FIG. 5 further illustrates complementary cross sectional profiles of cylinder liner 16 and gasket body 22. In particular, second axial end 94 of cylinder liner 16 may include a first cross sectional profile in a section plane which includes longitudinal axis A₁ of cylinder liner 16. Lower surface 32 of gasket body 22 may include a second cross sectional profile in a section plane which includes center axis A₂ of cylinder opening 28 and having a shape complementary to the first cross sectional profile. While it is contemplated that compound sealing mechanism 20 may be used with cylinder liner 16 as assembly 110 in a practical implementation strategy, the components are not strictly limited to use together, and in other embodiments compound sealing mechanism 20 might be used with different cylinder liners, and likewise cylinder liner 16 might be used with a different sealing mechanism.

### INDUSTRIAL APPLICABILITY

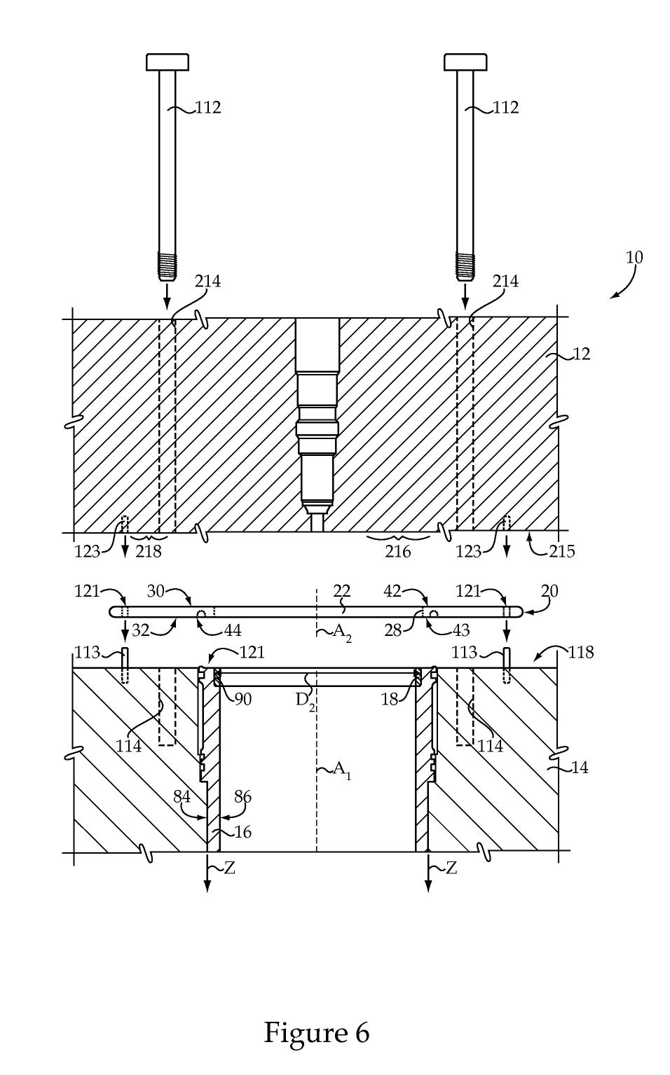

Referring to the drawings generally, and in particular to FIGS. 1 and 6, over the course of an engine's service life, or during rebuild in preparation for returning to service, it may be desirable to service and/or replace certain components. Among these components may be one or more of cylinder liners 16 and one or more of compound sealing mechanisms 20. It is also contemplated that cylinder liners 16 and compound sealing mechanisms 20 may be used in manufacturing of new engines, or retrofitted into existing internal combustion engines. As discussed above, each compound sealing mechanism 20 may be used in establishing fluid seals associated with a single cylinder 19/cylinder liner 16. The present disclosure is not thusly limited, however, and embodiments are contemplated having multiple combustion seals and a relatively large number of fluid transfer seals in a single gasket body to provide the necessary fluid sealing functions for multiple cylinders. Similarly, while a multi-unit engine head configuration as described herein may be used, in other embodiments a single engine head unit might be used. The following description should thus be understood to refer similarly to assembly of new engines, reassembly of existing engines with new or remanufactured components, engines having separate or composite head units, and engine have individual or composite compound sealing mechanisms.

Disassembly and servicing of engine 10 may take place generally in a conventional manner. Each of the individual head units of engine head 12 may be decoupled from housing 14 and existing combustion seals and head gaskets removed. Existing cylinder liners may be removed and replaced if desired. It will be recalled that cylinder liners 16 may include retrofit cylinder liners. Thus, removal of existing cylinder liners might include removing cylinder liners having a configuration different from cylinder liners 16, for example having protective end projections positioned adjacent an inner surface rather than protective end projections positioned adjacent an outer surface. Similarly, compound sealing mechanisms 20 may include retrofit sealing mechanisms. Thus, removal of existing sealing mechanisms may include removal of sealing mechanisms having a different configuration than compound sealing mechanisms 20. It was common in earlier systems to use separate components for head gasket versus combustion seal functions.

Assembling internal combustion engine 10, whether when engine 10 is new or returning to service after rebuild, servicing, etc., may include contacting cylinder liner sealing surface 43 of combustion seal 40 with sealing surface 100 of cylinder liner 16 when cylinder liner 16 is positioned within engine housing 14. Assembling engine 10 may further include contacting engine head sealing surface 42 of combustion seal 40 with engine head 12 of engine 10. During contacting cylinder liner sealing surface 43 with cylinder liner 16, protective end projection 102 may be received within recess 44. Once engine head 12, compound sealing mechanism 20 and cylinder liner 16 are positioned appropriately, a sealing load may be applied to gasket body 22 by way of clamping gasket body 22 between engine housing 14 and engine head 12, as further described herein.

FIG. 6 illustrates engine 10 at an assembly stage prior to contacting cylinder liner sealing surface 43 with sealing surface 100 of cylinder liner 16. Those skilled in the art will be familiar with the relative precision that may be desirable in assembling various engine components. For instance, it will typically be desirable to position combustion seal 40 co-axially with cylinder liner 16. It may further be desirable to position combustion seal 40 co-axially with portions of engine head 12. To this end, a plurality of guide pins 113 may be pressed into engine housing 14. Gasket body 22 may then be piloted via an interaction of guide pins 113 with guide pin bores 121 in gasket body 22 to a position at which cylinder liner sealing surface 43 contacts sealing surface 100 of cylinder liner 16. Gasket body 22 may be simultaneously aligned at a position where axis A₂ overlaps axis A₁.

Engine head 12 may then be piloted via an interaction between guide pins 113 and guide pin bores 123 in engine head 12 into contact with gasket body 22 such that engine head sealing surface 42 contacts a lower surface 215 of engine head 12. Protective end projection 102 may be positioned within recess 44 during piloting gasket body 22 into contact with cylinder liner 16. Bolts 112 may then be passed through engine head 12, gasket body 22 and into bolting apertures 114, and secured in a conventional manner to clamp gasket body 22, engine head 12 and engine housing 14 together, and apply the desired sealing load. This general strategy of piloting gasket body 22 via guide pins 112 differs from earlier techniques suitable for and specific to two-piece combustion seal and head gasket systems, where a cuff ring placed in the cylinder liner stood proud of the engine housing and piloted the combustion seal.

In certain instances, it may be desirable to apply a relatively greater sealing load to inner radial region 38 than to outer radial region 34. Peak pressure in the corresponding cylinder or cylinder liner 16 may necessitate a relatively tighter, more robust combustion seal than that required for fluid transfer seals 50. Accordingly, applying a sealing load may include applying a relatively greater load to inner radial region 38 than to outer radial region 34 via the clamping of gasket body 22 between engine head 12 and housing 14. Unequal sharing of the load between inner radial region 38 and outer radial region 34 may be achieved, for example, via machining engine head 12 such that surface 215 is slightly closer to engine housing 14 in a region 216 of surface 215 which contacts inner radial region 38, than a region 218 of surface 215 which contacts outer radial region 34. In other words, surface 215 may be machined to be slightly non-planar in order to apply disparate sealing loads to regions 34 and 38. Alternatively, an axial thickness of gasket body 22 could be tailored such that gasket body 22 is relatively thicker in inner radial region 38 than in outer radial region 34, or upper surface 118 of engine housing 14 might be machined to be non-planar. Further still, bolting apertures 46, 114 and 214 might be located such that the sealing load is applied relatively closer to or within inner radial region 38, imparting a relatively greater proportion of the load to inner radial region 38 than to outer radial region 34.

In some engines, the relatively high sealing load applied to a combustion seal via bolting the engine head to the engine housing can tend to deform a cylinder liner. In particular, a cylinder liner may flare outwardly in a direction normal to its center axis under a bolting load applied to seal the combustion seal. Such deformation may be especially problematic in the presence of relatively high combustion temperatures and pressures experienced by the cylinder liner and associated components. While deformation of a cylinder liner will typically be so small as to be imperceptible to the human eye, it may result in sealing problems about an engine piston, especially as the piston approaches a top dead center position in the cylinder liner. In particular, deformation can cause a gap between the cuff ring and piston to become larger. In some instances, liner deformation can also cause the outer surface of the cuff ring to no longer seal against the inner surface of the liner. As a result of these phenomena, combustion gases can escape the engine cylinder via a phenomenon known in the art as “blow-by.” Certain earlier strategies attempted to limit cylinder liner deformation by forming cylinder liners with relatively thick liner walls. While this strategy has been shown to be relatively effective, in other instances it may be undesirable to utilize relatively thick cylinder liners. For example, certain engines may be adapted after service as a diesel engine to use as a natural gas engine. It is common for engine cylinders used in natural gas engines to have different configurations or dimensions than certain comparably sized diesel engines. Accordingly, the use of a relatively thinner cylinder liner versus a thick walled liner can preserve a relatively larger amount of engine housing material for later re-boring of an engine cylinder to render it amenable to use as a natural gas engine in a subsequent service life.

The present disclosure also departs from conventional, thick liner strategies by, among other things, configuring cylinder liners and the associated sealing mechanisms in specialized ways to limit cylinder liner deformation without the need for a relatively large bore to accommodate a relatively thick walled cylinder liner. The combination of various features described herein, such as the relatively thin wall thickness t of cylinder liners 16, the length of liner flange height F relative to bore diameter D₁, and the length L of the flange height relative to overall liner length, all combine to create a cylinder liner which may be subjected to a suitable sealing load without deforming the cylinder liner and causing combustion gas blow-by or other problems. The present disclosure further departs from certain conventional strategies in that the sealing load applied to combustion seal 40 follows a load path, shown with arrows Z in FIG. 6 which is approximately parallel axis A₁ and concentrated between inner surface 86 and outer surface 84. By positioning protective end projection 102 adjacent to outer surface 84 rather than inner surface 86, as in certain earlier strategies, the location of combustion seal 40 can be made relatively close to axis A₁. As a result, the sealing load tends to be transmitted through cylinder liner 16 via a load path less apt to cause outward flaring thereof. This characteristic enables wall thickness t to remain relatively thin, and may allow for the use of reduced sealing loads in certain instances.

A further feature resulting from placing combustion seal 40 relatively close to axis A₁, and hence making inner perimeter 26 close to inner surface 86 of liner body 80, is a reduction in “crevice volume” as compared with earlier designs where the combustion seal was positioned radially outward of the protective end projection of a cylinder liner. Reducing crevice volume results in less space in the cylinder where fuel and air combustion tends to occur incompletely, or otherwise differently from a manner desired.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims.

What is claimed is:

1. A compound sealing mechanism for sealing between an engine head and an engine housing of an internal combustion engine comprising:
a one-piece gasket body including an outer perimeter, and an inner perimeter defining a cylinder opening having a center axis, the one-piece gasket body further including an upper surface extending in a radial direction between the inner perimeter and the outer perimeter, a lower surface positioned opposite the upper surface, and an outer radial region which includes a plurality of apertures communicating between the upper surface and the lower surface;
the one-piece gasket body further having an inner radial region which includes a combustion seal having an engine head sealing surface and a cylinder liner sealing surface, the cylinder liner sealing surface including a portion of the lower surface and being positioned adjacent the inner perimeter; and
the one-piece gasket body further includes a recess in the lower surface located radially outward of the cylinder liner sealing surface and being configured to receive therein a protective end projection of a cylinder liner.

2. The compound sealing mechanism of claim 1 wherein the cylinder opening includes a circular shape, and wherein the recess includes a continuous annular recess circumferential of the center axis of the cylinder opening and adjoining the cylinder liner sealing surface.

3. The compound sealing mechanism of claim 2 wherein the plurality of apertures includes a set of bolting apertures arranged in a first radial pattern about the center axis, and a set of fluid transfer apertures arranged in a second radial pattern about the center axis which is different from the first radial pattern, the one-piece gasket body further including a plurality of fluid transfer seals associated one with each of the plurality of fluid transfer apertures.

4. The compound sealing mechanism of claim 3 wherein:
the outer perimeter includes a non-uniform outer perimeter having a first perimeter segment defining a first minor lobe of the outer radial region, and a second perimeter segment defining a second minor lobe of the outer radial region;
the outer perimeter further includes a third perimeter segment located between the first perimeter segment and the second perimeter segment and defining a first major lobe of the outer radial region, and a fourth perimeter segment also located between the first perimeter segment and the second perimeter segment and defining a second major lobe of the outer radial region;
a first number of the bolting apertures are located in the first major lobe and define a first arc of a circle arranged coaxially with the cylinder opening, and a second number of the bolting apertures equal to the first number are located in the second major lobe and define a second arc of the circle; and
the first arc includes a first midpoint and the second arc includes a second midpoint, and a line segment defined by the first midpoint and the second midpoint intersects the center axis of the cylinder opening.

5. The compound sealing mechanism of claim 4 wherein the set of bolting apertures includes a total of six bolting apertures, and wherein the set of fluid transfer apertures includes a number of fluid transfer apertures greater than six.

6. The compound sealing mechanism of claim 3 wherein the cylinder liner sealing surface defines a first sealing plane and the engine head sealing surface defines a second sealing plane parallel to the first sealing plane, and wherein the cylinder liner sealing surface and the engine head sealing surface are located at overlapping radial positions relative to the center axis of the cylinder opening.

7. The compound sealing mechanism of claim 6 wherein the combustion seal includes a multi-layer combustion seal having a plurality of sheets of material between the cylinder liner sealing surface and the engine head sealing surface, including a first metallic sheet which includes the cylinder liner sealing surface, a second metallic sheet which includes the engine head sealing surface and a metallic spring sheet sandwiched between the first metallic sheet and the second metallic sheet, the metallic spring sheet having a planar loaded state and a non-planar unloaded state.

8. A cylinder liner for an internal combustion engine comprising:
a liner body including a liner wall having an outer surface and an inner surface defining a first longitudinal bore with a first bore diameter and a second longitudinal bore with a second bore diameter which is greater than the first bore diameter, the first longitudinal bore and the second longitudinal bore defining a common longitudinal axis;
the liner body further having a first axial end, a second axial end and a plurality of axial segments, including a first axial segment which includes the first axial end and the first longitudinal bore and a second axial segment which includes the second axial end and the second longitudinal bore, wherein the first axial segment includes a first segment diameter and the second axial segment includes a second segment diameter which is greater than the first segment diameter;
the second axial end including a sealing surface extending in a radial direction between the inner surface and the outer surface, and a protective end projection adjoining the sealing surface and projecting in an axial direction from the sealing surface, the sealing surface being located adjacent to the inner surface and the protective end projection being positioned relatively closer to the outer surface than to the inner surface; and
the first axial segment including a wall thickness of the liner wall between the inner surface and the outer surface, the wall thickness being equal to about 12% or less of the first bore diameter.

9. The cylinder liner of claim 8 wherein the protective end projection includes a continuous annular projection adjoining the outer surface and being coaxial with the first and second longitudinal bores.

10. The cylinder liner of claim 9 wherein the sealing surface defines a plane, and wherein the protective end projection includes a first edge surface transitioning to and adjoining the outer surface of the cylinder liner, a second edge surface transitioning to and adjoining the sealing surface and a planar axial end surface extending from the first edge surface to the second edge surface and defining another plane parallel to the plane defined by the sealing surface.

11. The cylinder liner of claim 9 wherein:
the first axial segment includes a liner seat, a distance from the sealing surface to the liner seat defining a liner flange height, and a distance from the first axial end to the second axial end defines a liner length; and
the liner flange height is equal to about 60% or less of the first bore diameter, and equal to about 30% or more of the liner length.

12. The cylinder liner of claim 11 wherein the wall thickness being equal to about 8% or less of the first bore diameter.

13. The cylinder liner of claim 12 wherein the first bore diameter is equal to about 150 millimeters or less, the wall thickness is equal to about 12 millimeters or less, the liner flange height is equal to about 85 millimeters or less and the liner length is equal to about 300 millimeters or less.

14. A cylinder liner and compound seal assembly for an internal combustion engine comprising:
a cylinder liner including a liner body having an outer surface and an inner surface defining a longitudinal bore which includes a longitudinal axis, the cylinder liner further including a first axial end, and a second axial end which includes a sealing surface extending in a radial direction between the inner surface and the outer surface and a protective end projection extending in an axial direction from the sealing surface; and
a compound sealing mechanism including a one-piece gasket body having an outer perimeter and an inner perimeter defining a cylinder opening which includes a center axis, the one-piece gasket body further including an upper surface extending in a radial direction between the inner perimeter and the outer perimeter, a lower surface positioned opposite the upper surface, and an outer radial region which includes a plurality of apertures communicating between the upper surface and the lower surface;
the one-piece gasket body further having an inner radial region which includes a combustion seal having an engine head sealing surface and a cylinder liner sealing surface, the cylinder liner sealing surface including a portion of the lower surface and being positioned adjacent the inner perimeter; and
the one-piece gasket body further includes a recess in the lower surface located radially outward of the cylinder liner sealing surface and being configured to receive therein the protective end projection of the cylinder liner.

15. The assembly of claim 14 wherein the recess includes a continuous annular recess circumferential of the center axis of the cylinder opening and positioned adjacent the cylinder liner sealing surface, and wherein the protective end projection includes a continuous annular projection received in the recess when the cylinder liner sealing surface contacts the sealing surface of the cylinder liner and the cylinder opening is arranged coaxially with the longitudinal bore.

16. The assembly of claim 15 wherein:
the plurality of apertures includes a set of bolting apertures arranged in a first radial pattern about the center axis and a set of fluid transfer apertures arranged in a second radial pattern about the center axis which is different from the first radial pattern; and
the outer perimeter further includes a perimeter segment defining a first lobe of the outer radial region having three of the bolting apertures and a plurality of the fluid transfer apertures located therein, and another perimeter segment defining a second lobe of the outer radial region and also having three of the bolting apertures and a plurality of the fluid transfer apertures located therein.

17. The assembly of claim 16 wherein:
the liner body includes a liner wall having an outer surface and an inner surface defining the longitudinal bore, the longitudinal bore including a first longitudinal bore having a first bore diameter, and the inner surface defining a second longitudinal bore coaxial with the first longitudinal bore and having a second bore diameter which is greater than the first bore diameter;
the protective end projection adjoins the sealing surface and projects in an axial direction from the sealing surface, the sealing surface being located adjacent to the inner surface and the protective end projection being located adjacent to the outer surface and positioned relatively closer to the outer surface than the inner surface; and
the second axial end of the cylinder liner includes a first cross sectional profile in a section plane which includes the longitudinal axis of the cylinder liner, and the lower surface of the one-piece gasket body includes a second cross sectional profile in a section plane which includes the center axis of the cylinder opening and having a shape complementary to the first cross sectional profile.

18. A method of assembling an internal combustion engine comprising the steps of:
contacting a cylinder liner sealing surface of a combustion seal with a cylinder liner positioned within an engine housing of the internal combustion engine;
contacting an engine head sealing surface of the combustion seal with an engine head of the internal combustion engine;
receiving a protective end projection of the cylinder liner within a recess formed in a lower surface of a one-piece gasket body which includes the combustion seal; and
applying a sealing load to the one-piece gasket body at least in part via a step of clamping the one-piece gasket body between the engine head and the engine housing.

19. The method of claim 18 wherein the step of applying a sealing load further includes, applying a first load to an inner radial region of the one-piece gasket body which includes the combustion seal and applying a second, different load to an outer radial region of the one-piece gasket body which includes a plurality of fluid transfer seals, without applying a load to the protective end projection.

20. The method of claim 19 wherein the step of contacting the cylinder liner sealing surface further includes piloting the one-piece gasket body into contact with the cylinder liner via receiving a plurality of guide pins within a plurality of guide pin bores of the one-piece gasket body.

21. The method of claim 19 further comprising a step of transmitting the sealing load through the cylinder liner at least predominantly along a load path located between an inner surface and an outer surface of the cylinder liner and oriented parallel to a longitudinal axis of the cylinder liner.
